(19) United States
(12) Patent Application Publication
(10) Pub. No.: US 2012/0102473 A1
(43) Pub. Date: Apr. 26, 2012

(54) ABSTRACT METHOD REMOVAL FOR REDUCED MEMORY FOOTPRINT WITH OPTIMIZER TOOL

(75) Inventor: Berthold M. Lebert, Phoenix, AZ (US)

(73) Assignee: INTERNATIONAL BUSINESS MACHINES CORPORATION, Armonk, NY (US)

(21) Appl. No.: 12/910,803

(22) Filed: Oct. 23, 2010

(51) Int. Cl. G06F 9/45

(52) U.S. Cl. 717/151

(57) ABSTRACT

A compiler compiles a set of code to generate compiled code having a first size. Further, an optimization tool, which is operably connected to a processor, automatically removes one or more abstract method definitions from the compiled code by iteratively examining each class file in the complied code and only adding the class file without the one or more abstract method definitions to an output file. The output file has a second size that is less than the first size. In addition, the output file is deployed after the automatic removal of the one or more abstract method definitions.

### BACKGROUND

1. Field

This disclosure generally relates to a computing environment. More particularly, the disclosure relates to optimization of compiled code.

2. General Background

In general, as programmable computer processing is becoming more prevalent in a larger array of devices, e.g., handheld devices, smart appliances, embedded systems, etc., efficient utilization of computing resources has become more of a concern. An example of such a computing resource is memory, which stores one or more computer programs that control a computing device. Many of these computer programs tend to sacrifice program size for other efficiencies. The computer programs that are written in object oriented languages especially have such a tendency. Although the efficiencies typically allow program source code to be written and implemented faster than without such efficiencies, the complied program may include constructs that increase the size of the complied program without providing any actual function at runtime. As a result the implementation of the complied objected oriented code may be efficiently implemented, but not efficiently executed at runtime.

### SUMMARY

In one embodiment of the invention, a computer program product is provided for multi-threading. The computer program product includes a computer readable storage medium having computer readable program code embodied therewith. Computer readable program code is configured to compile a set of code to generate compiled code having a first size. Further, the computer readable code is configured to automatically remove, with an optimization tool operably connected to a processor, one or more abstract method definitions from the compiled code by iteratively examining each class file in the complied code and only adding the class file without the one or more abstract method definitions to an output file. The output file has a second size that is less than the first size. In addition, the computer readable code is configured to deploy the output file after the automatic removal of the one or more abstract method definitions.

In another embodiment of the invention, a process is provided. The process compiles, with a compiler, a set of code to generate compiled code having a first size. Further, the process automatically removes, with an optimization tool operably connected to a processor, one or more abstract method definitions from the compiled code by iteratively examining each class file in the complied code and only adding the class file without the one or more abstract method definitions to an output file. The output file has a second size that is less than the first size. In addition, the process deploys the output file after the automatic removal of the one or more abstract method definitions.

In yet another embodiment of the invention, a system is provided. The system includes a compiler, which is operably connected to a processor, that compiles a set of code to generate compiled code having a first size. Further, the system includes an optimization tool, which is operably connected to the processor, that automatically removes one or more abstract method definitions from the compiled code by iteratively examining each class file in the complied code and only adding the class file without the one or more abstract method definitions to an output file. The output file has a second size that is less than the first size. In addition, the system includes a deployment module that deploys the output file after the automatic removal of the one or more abstract method definitions.

### DRAWINGS

The above-mentioned features of the present invention will become more apparent with reference to the following description taken in conjunction with the accompanying drawings wherein like reference numerals denote like elements and in which:

FIG. 1 illustrates an optimization system according an embodiment of the present invention.

FIG. 2 illustrates a process according to an embodiment of the present invention.

FIG. 3 illustrates another process according to an embodiment of the present invention.

FIG. 4 illustrates a block diagram of a system that performs optimization according to an embodiment of the present invention.

### DETAILED DESCRIPTION

An object oriented program consists of classes, each which contain methods (or functional members, or functions) that contain the instructions to run the program. Classes also contain data members (fields). Classes are “instantiated” in order to create objects. Each object contains its own set of data as specified by the data members of the class, and the functional members of any given object are capable of acting on the data members of the object.

Some languages allow for the definition of “abstract” classes and interfaces. Similar to interfaces, abstract classes cannot be “instantiated”. Abstract classes and interfaces may contain abstract methods. These abstract methods are rules for classes which extend an abstract class or implement an interface to provide a concrete implementation of the abstract method. This technique allows for the development of robust extensible application frameworks at the cost of some overhead.

In certain programming languages, the class file is the structure which maintains the definition of a class and its members prior to runtime. Each class file maintains a list of the methods. The list includes the abstract methods. These lists consume file space. The amount of memory consumed can add up with a large number of classes and methods. On some platforms, e.g., embedded and mobile device platforms, memory usage has to be kept to a minimum. Small differences in memory requirements make a significant difference in cost savings in relation to the cost of the device.

In one embodiment of the present invention, one or more abstract method definitions in compiled class files are eliminated. An automated procedure may be performed by an optimization tool after development of the software program or library has completed, but prior to deployment of the application on a platform or device, in order to reduce memory usage and increase performance on the platform file system. Therefore, the changes would be invisible to the developer and to the user of the software, but would achieve savings in the deployment of the software. The user of the software would notice no difference in the behavior of the running programs.

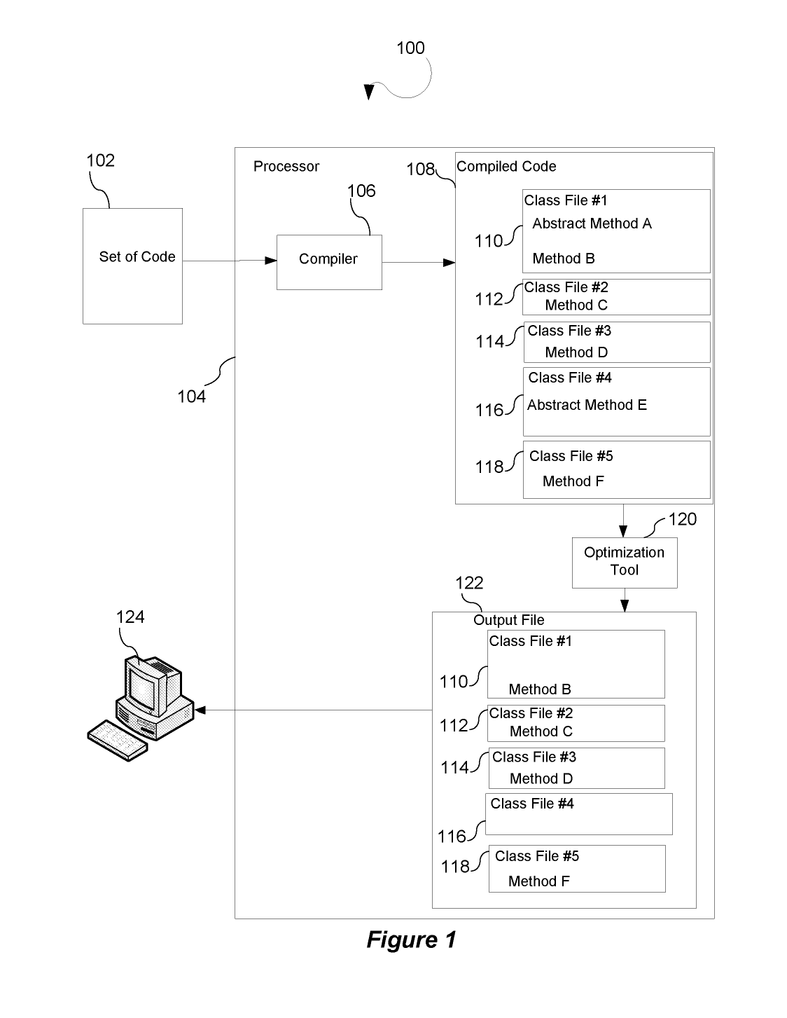

FIG. 1 illustrates an optimization system 100 according an embodiment of the present invention. A set of code 102 is developed by a developer. The set of code 102 is provided to a processor 104. The processor 104 has a compiler 106 that compiles the set of code 102 to generate compiled code 108. As an example, the compiled code 108 may have a first class file 110, a second class file 112, a third class file 114, a fourth class file 116, and a fifth class file 118. The first class file 110 has an abstract method A in addition to a method B that is not abstract. The second class file 112 has a method C that is not an abstract method. Further, the third class file 114 has a method D that is not an abstract method. In addition, the fourth class file 116 has an abstract method E. Finally, the fifth class file 118 has a method F that is not abstract. The compiled code 108 is provided to an optimization tool 120. The optimization tool 120 may automatically remove one or more abstract methods from the compiled code by iteratively examining each class file in the complied code and only adding the class file without the one or more abstract method definitions to an output file 122. In one embodiment, an object oriented language may have every class in a file, i.e., (<className>.class). Further, the class files may be packaged together into an archive file or virtual machine format. Accordingly, the output file 122 will have one or more less abstract methods to help improve runtime efficiency on a computing device 124 to which the output file 122 is deployed for execution. As an example, the optimization tool 120 removes the abstract method A in the first class file 110 and the abstract method definition from the abstract method E in the fourth class file 116. As the fourth class file 116 does not have any remaining methods that are not abstract, that class file is empty. The computing device 124 may be desktop computer, laptop, smart phone, personal digital assistant (“PDA”), personal media player (“PMP”), smart appliance, or the like. The number of class files may vary from what is illustrated in FIG. 1. Further, none, some, or all of the class files may have methods that are abstract.

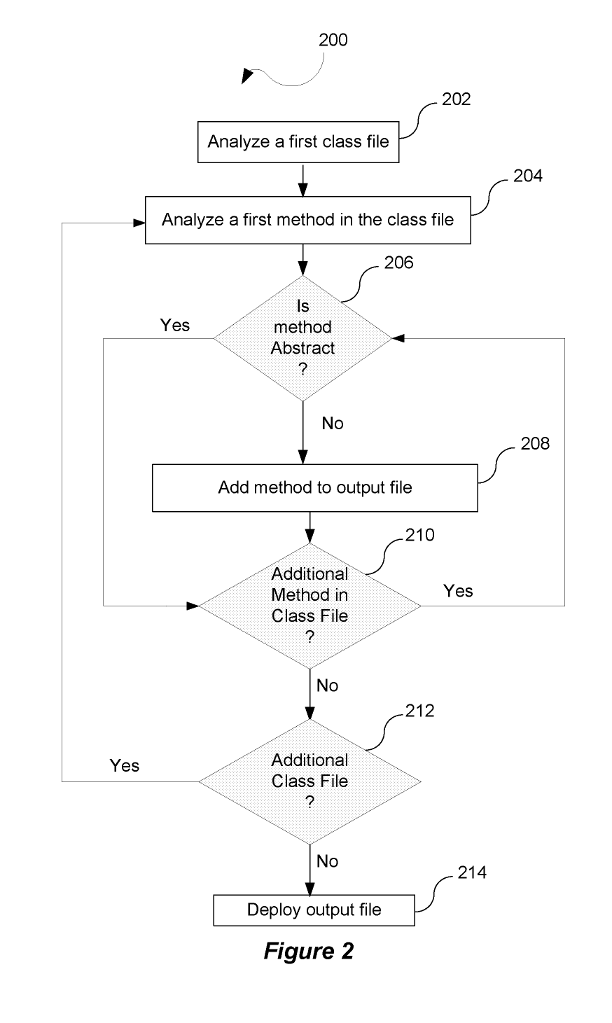

FIG. 2 illustrates a process 200 according to an embodiment of the present invention. At a process block 202, the process 200 analyzes a first class file in the complied code 108 illustrated in FIG. 1. Further, at a process block 204, the process 200 analyzes a first method in the class file. In addition, at a decision block 206, the process 200 determines if the method is abstract. If the method is not abstract, the process 200 advances to process block 208 to add the method to the output file 122. The process 200 then advances to a decision block 210 to determine if an additional method that has not yet been analyzed is present in the class file. At the decision block 206, if the process 200 determines that the method was abstract, the process 200 ignores the method and advances to the decision block 210. At the decision block 210, the process 200 determines if an additional method that has not yet been analyzed is present in the class file. If the process 200 determines that an additional method that has not yet been analyzed is present in the class file, the process 200 reverts back to the decision block 206 to analyze the next method. At the decision block 210, if the process 200 determines that no additional method is present in the class file, the process 200 advances to a decision block 212 to determine if an additional class that has not yet been analyzed is present. If the process 200 determines that an additional class file that has not yet been analyzed is present, the process 200 reverts back to the process block 204 to analyze a first method in the additional class file. At the decision block 212, if the process 200 determines that no additional class file that has not yet been analyzed is present, the process 200 deploys the output file 112.

Accordingly, abstract methods in interfaces and abstract class can be removed. As an example, an approximate range of twelve to several hundred bytes may be saved per method depending on the number types of arguments in the method signature and the number of exceptions listed in the throws clause of the method.

As an example, the implementation class (abstractMethodsRemoved.Implementor) extends an abstract class and implements two interfaces. Further, the implementation class is compiled against the “abstract_complete.jar” file which contains the complete abstract classes including the abstract methods:

j9 -cp abstract_complete.jar;impl.jar
abstractMethodsRemoved.Implementor

<Loaded abstractMethodsRemoved/Implementor>
< Class size 1081; ROM size 1240; debug size 0>
< Read time 0 usec; Load time 30 usec; Translate time 46 usec>
<Loaded abstractMethodsRemoved/AbstractClass>
< Class size 322; ROM size 328; debug size 0>
< Read time 5 usec; Load time 25 usec; Translate time 31 usec>
<Loaded abstractMethodsRemoved/InterfaceWithMethod>
< Class size 160; ROM size 168; debug size 0>
< Read time 5 usec; Load time 17 usec; Translate time 13 usec>
<Loaded abstractMethodsRemoved/InterfaceWithMethods>
< Class size 174; ROM size 192; debug size 0>
< Read time 5 usec; Load time 17 usec; Translate time 13 usec>

At runtime the “abstract_complete.jar” can be replaced with the “abstract_empty.jar” file on the classpath of the application. The “abstract_empty.jar” file contains the abstract class and interfaces without abstract method definitions:

j9 -cp abstract_empty.jar;impl.jar abstractMethodsRemoved.Implementor

<Loaded abstractMethodsRemoved/Implementor>
< Class size 1081; ROM size 1240; debug size 0>
< Read time 0 usec; Load time 31 usec; Translate time 46 usec>
<Loaded abstractMethodsRemoved/AbstractClass>
< Class size 310; ROM size 288; debug size 0>
< Read time 6 usec; Load time 24 usec; Translate time 28 usec>
<Loaded abstractMethodsRemoved/InterfaceWithMethod>
< Class size 142; ROM size 152; debug size 0>
< Read time 6 usec; Load time 17 usec; Translate time 13 usec>
<Loaded abstractMethodsRemoved/InterfaceWithMethods>
< Class size 144; ROM size 152; debug size 0>
< Read time 5 usec; Load time 15 usec; Translate time 11 usec>

As a result, Class and ROM seizes are reduced in addition to times beings faster.

The process 200 illustrates an embodiment of the present invention in which the abstract methods are ignored and not added to the output file 122. In an alternative embodiment, the abstract methods may be deleted from the output file 122.

Further, in one embodiment, the optimization tool 120 may be configured to selectively ignore or remove abstract methods. For example, some native abstract methods may have to be on a particular platform. Accordingly, the optimization tool 120 may be configured so that one or more particular abstract methods are not ignored or removed.

In some situations, not all abstract methods may be removed without causing runtime errors. In one embodiment, the existing byte code is modified to avoid such runtime errors. The modifications to the byte code will not alter the runtime behavior of the program.

As an example of such a modification to the byte code, the abstract class P may define a method m( ) and the class S that extends the abstract class P. The abstract class P may implement the method m( ) as follows:

```
public abstract class P {
    abstract public void m( );
}
public class S extends P {
    public void m( ) {
        /* do something */
    }
    void run( ) {
        /* code details below */
    }
}
```

If the method m( ) in the abstract class P is removed, then the following direct and indirect usages of method P.m( ) are considered. First, an example of using the method (m) in the concrete class S directly is as follows:

```
void run( ) {
    S s = new S( );
    s.m( );
}
```

This example is the standard situation, which will work without further modification.

Further, an example of declaring the variable as type P and calling the method m( ) in the abstract class P is as follows:

```
void run( ) {
    P p = new S( );
    p.m( );
}
```

The result of this example is a NoSuchMethodError to be thrown when the run( ) method is invoked at runtime. An example of a possible modification is to change the type declaration of the local to or insert a cast to implementation class S:

```
void run( ) {
    S p = new S( );
    p.m( );
}
void run( ) {
    P p = new S( );
    ((S)p).m( );
}
```

In addition, an example of utilizing the abstract class P as an anonymous inner class is as follows:

```
void run( ) {
    P p = new P( ) {
        public void m( ) {
        /* do something */
        }
    };
    p.m( );
}
```

The result of this example is also a NoSuchMethodError. However, the approach to solve this by changing the type declaration of the local to or inserting a cast to implementation class S fails with ClassCastException. In this situation, the anonymous inner class is transformed into a named inner class as follows:

```
class SP extends P {
    public void m( ) {
        /* do something */
    }
};
void run( ) {
    SP p = new SP( ); // must also declare type of named inner class
    p.m( );
}
```

No class size increase results if the inner class name can be kept short.

Further, if the anonymous inner class is utilizing an interface instead of an abstract class, the modifications are the same as illustrated in the following example:

```
void run( ) {
    I i = new I( ) { // Interface I with method i( )
        public void i( ) { }
    };
    i.i( );
}
```

A NoSuchMethodError also results, the anonymous inner class is transformed into a named inner class as follows:

```
class II implements I {
    public void i( ) { }
};
void run( ) {
    II i = new II( ); // must also declare type of named inner class
    i.i( );
}
```

As another example, the interface may be utilized as an argument type as follows:

```
public class C implements I {
    public void i( ) {
        System.err.println(“i”);
    }
    static void m2(I i) {
        i.i( );
    }
    void run( ) {
        m2(new C( ));
    }
}
```

As a result, the call to m2( ) fails. In this situation, if no other class implements the interface I and calls the method m2(I), then the argument type of m2(I) may be changed to m2(C) as follows:

static void m2(C i) {
i.i( );
}

If another class implements the interface I and calls the method m2(I), then the method cannot be removed without the addition the code which defeats the purpose improving efficiency. In this situation, this abstract method can only be removed by changes in the virtual machine to not throw the error when performing type checking.

In one embodiment, a process determines if the target type is an Interface or an Abstract Class and the option ignoreMissingAbstractMethods is not set. If so, the process gets the target method in Interface and if not found throws NoSuchMethodError. Otherwise, the process continues. The process proceeds to get the target method in the target object. The process then executes the target method. In one embodiment, this process involves the classes being pre-verified.

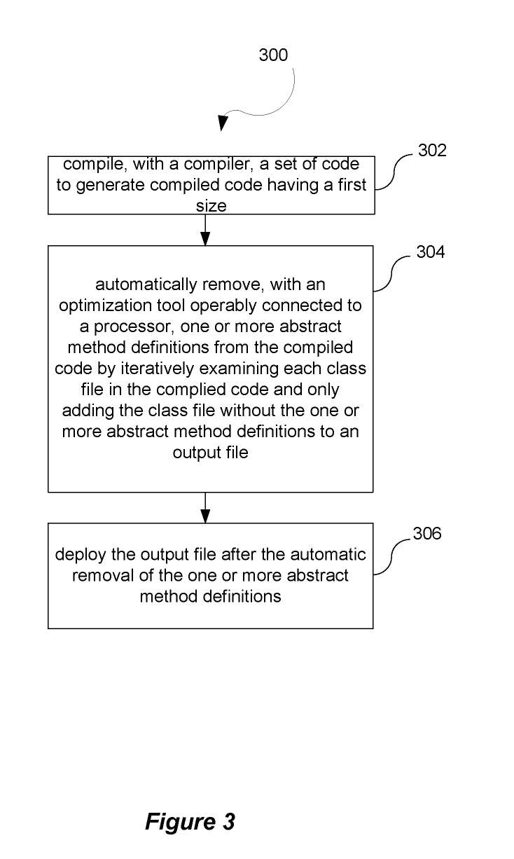

FIG. 3 illustrates another process 300 according to an embodiment of the present invention. At a process block 302, the process 300 compiles, with a compiler, a set of code to generate compiled code having a first size. Further, at a process block 304, the process 300 automatically removes, with an optimization tool operably connected to a processor, one or more abstract method definitions from the compiled code by iteratively examining each class file in the complied code and only adding the class file without the one or more abstract method definitions to an output file. The output file has a second size that is less than the first size. In addition, at a process block 306, the process 300 deploys the output file after the automatic removal of the one or more abstract method definitions.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool.

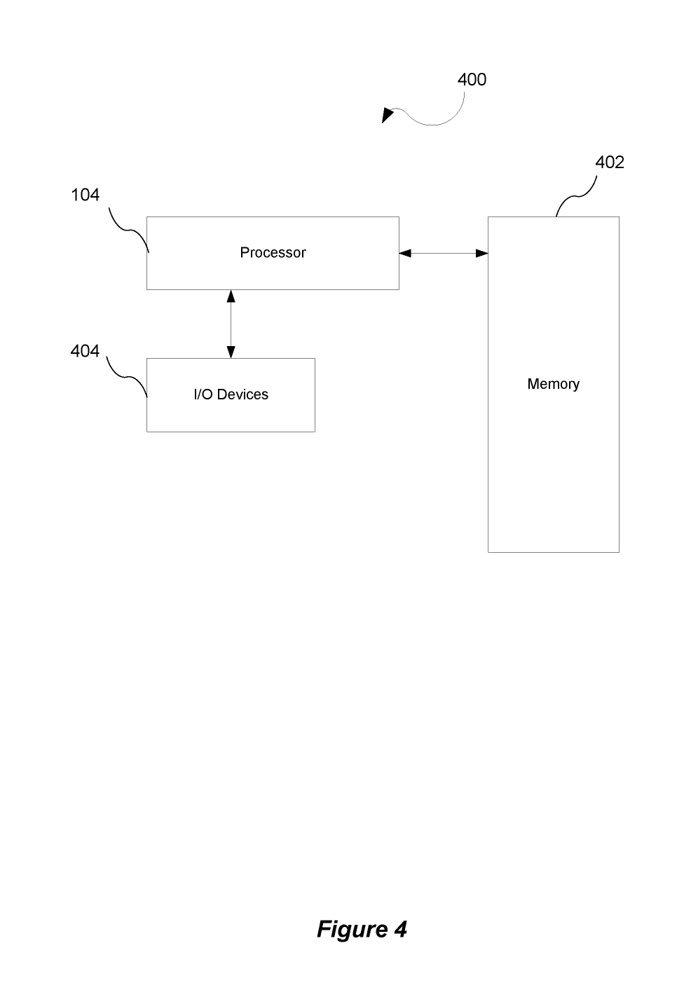

FIG. 4 illustrates a block diagram of a system 400 that performs optimization according to an embodiment of the present invention. In one embodiment, the system 400 is suitable for storing and/or executing program code and is implemented using a general purpose computer or any other hardware equivalents. Thus, the system 400 comprises the processor 104, a memory 402, e.g., random access memory (“RAM”) and/or read only memory (“ROM”), and various input/output devices 404.

The processor 104 is coupled, either directly or indirectly, to the memory 402 through a system bus. The memory 402 may include local memory employed during actual execution of the program code, bulk storage, and/or cache memories which provide temporary storage of at least some program code in order to reduce the number of times code must be retrieved from bulk storage during execution.

The input/output devices 404 may be coupled directly to the system 400 or through intervening input/output controllers. Further, the input/output devices 404 may include a keyboard, a keypad, a mouse, a microphone for capturing speech commands, a pointing device, and other user input devices that will be recognized by one of ordinary skill in the art. Further, the input/output devices 404 may include a receiver, transmitter, speaker, display, image capture sensor, biometric sensor, etc. In addition, the input/output devices 604 may include storage devices such as a tape drive, floppy drive, hard disk drive, compact disk (“CD”) drive, digital video disk (“DVD”) drive, etc.

Network adapters may also be coupled to the system 400 to enable the system 400 to become coupled to other systems, remote printers, or storage devices through intervening private or public networks. Modems, cable modems, and Ethernet cards are just a few of the currently available types of network adapters.

For any of the configurations described herein, various actions may take place when the call stack is retrieved. In one embodiment, the retrieved call stack is walked into a tree and the leaf node of the tree has its base count incremented, which allows for utilization of technology to produce reports or to view the collected information.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The “processor” of a general purpose computer, special purpose computer, or other programmable data processing apparatus may be referred to herein as a “microprocessor.” However, the term “microprocessor” should not be interpreted as being limited to a single-chip central processing unit or any other particular type of programmable data processing apparatus, unless explicitly so stated.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Reference throughout this Specification to “one embodiment,” “an embodiment,” or similar language means that a particular feature, structure, or characteristic described in connection with the embodiment is included in at least one embodiment of the present invention. Thus, appearances of the phrase “in one embodiment,” “in an embodiment,” and similar language throughout this Specification may, but do not necessarily, all refer to the same embodiment. Furthermore, the described features, structures, or characteristics of the invention may be combined in any suitable manner in one or more embodiments. Correspondingly, even if features are initially claimed as acting in certain combinations, one or more features from a claimed combination may in some cases be excised from the combination, and the claimed combination may be directed to a subcombination or variation of a subcombination.

While the computer program product, method and system have been described in terms of what are presently considered to be the most practical and preferred embodiments, it is to be understood that the disclosure need not be limited to the disclosed embodiments. The disclosure is intended to cover various modifications and similar arrangements included within the spirit and scope of the claims, the scope of which should be accorded the broadest interpretation so as to encompass all such modifications and similar structures. The present disclosure includes any and all embodiments of the following claims.

I claim:

1. A computer program product for multi-threading, the computer program product comprising:
a computer readable storage medium having computer readable program code embodied therewith, the computer readable program code comprising:
computer readable program code configured to compile a set of code to generate compiled code having a first size;
computer readable program code configured to automatically remove, with an optimization tool operably connected to a processor, one or more abstract method definitions from the compiled code by iteratively examining each class file in the complied code and only adding the class file without the one or more abstract method definitions to an output file, the output file having a second size that is less than the first size; and
computer program code configured to deploy the output file after the automatic removal of the one or more abstract method definitions.

2. The computer program product of claim 1, wherein the complied code is written in an object oriented language.

3. The computer program product of claim 1, further comprising computer program code configured to modify byte code to solve one or more runtime errors that result form the automatic removal of the one or more abstract method definitions.

4. The computer program product of claim 1, wherein the output file is deployed to a device that achieves enhanced performance as a result of less memory usage effectuated by the automatic removal.

5. The computer program product of claim 1, wherein the output file is deployed to a platform that achieves enhanced performance as a result of less memory usage effectuated by the automatic removal.

6. The computer program product of claim 1, wherein the automatic removal is hidden from a developer of the set of code.

7. The computer program product of claim 1, wherein the automatic removal is hidden from a user of the output file.

8. A method comprising:
compiling, with a compiler, a set of code to generate compiled code having a first size;
automatically removing, with an optimization tool operably connected to a processor, one or more abstract method definitions from the compiled code by iteratively examining each class file in the complied code and only adding the class file without the one or more abstract method definitions to an output file, the output file having a second size that is less than the first size; and
deploying the output file after the automatic removal of the one or more abstract method definitions.

9. The method of claim 8, wherein the complied code is written in an object oriented language.

10. The method of claim 8, further comprising modifying byte code to solve one or more runtime errors that result form the automatic removal of the one or more abstract method definitions.

11. The method of claim 8, wherein the output file is deployed to a device that achieves enhanced performance as a result of less memory usage effectuated by the automatic removal.

12. The method of claim 8, wherein the output file is deployed to a platform that achieves enhanced performance as a result of less memory usage effectuated by the automatic removal.

13. The method of claim 8, wherein the automatic removal is hidden from a developer of the set of code.

14. The method of claim 8, wherein the automatic removal is hidden from a user of the output file.

15. A system comprising:
a compiler, which is operably connected to processor, that compiles a set of code to generate compiled code having a first size;
an optimization tool, which is operably connected to the processor, that automatically removes one or more abstract method definitions from the compiled code by iteratively examining each class file in the complied code and only adding the class file without the one or more abstract method definitions to an output file, the output file having a second size that is less than the first size; and
a deployment module that deploys the output file after the automatic removal of the one or more abstract method definitions.

16. The system of claim 15, wherein the complied code is written in an object oriented language.

17. The system of claim 15, wherein the output file is deployed to a device that achieves enhanced performance as a result of less memory usage effectuated by the automatic removal.

18. The system of claim 15, wherein the output file is deployed to a platform that achieves enhanced performance as a result of less memory usage effectuated by the automatic removal.

19. The system of claim 15, wherein the automatic removal is hidden from a developer of the set of code.

20. The system of claim 15, wherein the automatic removal is hidden from a user of the output file.
